(19) United States
(12) Patent Application Publication
(10) Pub. No.: US 2011/0181417 A1
(43) Pub. Date: Jul. 28, 2011

(54) Method and apparatus for beverage dispensing

(75) Inventors: Paul Haskayne, Whitegate (GB); Robert Walter Shettle, Huddersfield (GB)

(73) Assignee: Lancer Partnership, Ltd

(21) Appl. No.: 12/657,644

(22) Filed: Jan. 25, 2010

(51) Int. Cl. G08B 13/14; B67D 7/74; B67D 7/80

(52) U.S. Cl. 340/572.1; 222/129.1; 222/146.6

(57) ABSTRACT

A beverage dispenser (10) includes a concentrate container (30) coupled to a connector (46). The connector (46) couples gas to the concentrate container (30), and couples concentrate from the container (30) to a dispensing valve (44). A combined carbonation and refrigeration unit (38) produces cold soda and provides cooling for concentrate lines (52, 54, and 56) and for water line (50).

### TECHNICAL FIELD OF THE INVENTION

This invention relates generally to beverage technology, and more particularly to methods and apparatus for beverage dispensing.

### BACKGROUND OF THE INVENTION

Typical beverage dispensers combine beverage concentrates (sometimes referred to as syrups) with water (carbonated or still) to form finished beverages. Such dispensers are common is restaurants, convenience stores, and work places, for example.

Because of syrup, distribution, and maintenance costs, beverage dispensers are most commercially viable in relatively high volume placements. For example, in such high volume placements, relatively large syrup containers can be used without risk of the syrup becoming out of date, thus spreading syrup and distribution costs over many drinks. Similarly, dispenser maintenance costs are generally acceptable if spread over many drinks.

However, for relatively low volume placements, syrup, distribution, and maintenance costs can be too high, on a per drink basis, for a reasonable commercial proposition. Examples of such low volume placements include, without limitation, offices, work places, and small retail establishments.

Therefore, a need has arisen for an improved method and apparatus for beverage dispensing suitable for relatively low volume applications.

### SUMMARY OF THE INVENTION

In accordance with the teachings of the present invention, methods and apparatus for beverage dispensing are provided which eliminate or substantially reduce problems associated with prior art systems.

In one aspect of the present invention a beverage dispenser is provided that includes a concentrate container, a connector coupled to the concentrate container, the connector comprising a gas pin and a concentrate pin, the pins penetrating the container, each pin comprising an opening and a fluid flow path through the pin, such that a gas flow path is provided into the container through the gas pin and a concentrate flow path is provided from the container to the connector, a gas source coupled to the gas pin through the connector, the gas source supplying gas at a gas pressure, and a concentrate dispensing valve coupled to the concentrate pin through the connector, such that, upon activation of the concentrate dispensing valve, concentrate flows from the concentrate container through the concentrate pin and the concentrate dispensing valve due to the gas pressure.

In some embodiments, the concentrate container is a 2-litre PET package.

Also, in some embodiments, the connector comprises a piston coupled to a rotatable upper housing, and the pins are coupled to the piston, and wherein rotation of the upper housing causes the piston to move toward or away from the concentrate container.

In a particular embodiment, rotation of the upper housing in one direction moves the piston away from the concentrate container such that the pins are withdrawn from the container, and rotation in the other direction moves the piston toward the concentrate container such that the pins penetrate the concentrate container.

In particular embodiments, the connector comprises a normally closed gas valve coupled to the gas pin, and a normally closed concentrate valve coupled to the concentrate pin. Also, the beverage dispenser may comprise a receiving receptacle for receiving the connector, wherein the normally closed gas and concentrate valves open when the connector is coupled to the receptacle.

In some embodiments, the beverage dispenser includes a controller and an RFID tag coupled to the concentrate container, the controller being able to read information from the RFID tag. The RFID information may comprise data relating to the expiration date of the concentrate in the concentrate container, and the kind of concentrate in the container. Also, the information may comprise data that authenticates the concentrate container as an authorized container for use with the dispenser. The beverage dispenser may be configured such that the controller disables use of unauthorized containers.

Bonus flavor containers for supplying bonus flavors may also be provided.

In some embodiments, the beverage dispenser further includes a carbonator tank for producing soda, the soda being coupled to a soda dispensing valve.

Also, in some embodiments, the beverage dispenser may further include an evaporator inside the carbonator tank, such that the carbonator tank and soda in the carbonator tank are chilled.

A concentrate line may be wound around the carbonator tank, the concentrate line coupled to the concentrate pin and carrying concentrate from the concentrate container, such that heat transfer to the carbonator tank cools the concentrate. Also, a water line may be wound around the carbonator tank, the water line coupled to a source of water and carrying water, such that heat transfer to the carbonator tank cools the water.

In some embodiments, the cooled water is communicated to the carbonator tank to produce soda.

In another embodiment, the beverage dispenser further comprising an enclosure enclosing a carbonator tank, an evaporator, cooling water, and a concentrate line, such that the evaporator creates an ice bank from the cooling water, thereby cooling the carbonator tank and the concentrate line. In some other embodiments, a water line is provided within the enclosure.

Also, an agitator may be provided within the enclosure, magnetically coupled to a motor outside the enclosure, to circulate water around the ice bank.

The beverage dispenser may also include beverage lines outside the enclosure, and a recirculation pump may be provided within the enclosure magnetically coupled to a motor outside the enclosure, for pumping cool water from the enclosure to cool the beverage lines.

Important technical advantages are provided with the present invention, including, without limitation, the provision of a connector that penetrates a concentrate container, allowing gas to flow in and pressurize the container, and concentrate to flow out. This allows dispensing without the need for dispensing pumps.

Another technical advantage disclosed herein is the use of standard packaging for the concentrate container.

Another technical advantage disclosed herein is the provision of RFID tags on concentrate containers, thereby allowing control and monitoring of beverage dispensers.

Still another technical advantage disclosed herein is the provision of a combined carbonator and refrigeration system. This allows a small size, and efficient production of soda and chilling of beverage lines.

Another technical advantage disclosed herein is the small dispenser size achieved by the integration of various components. These and other advantages will be made evident by the following description.

### BRIEF DESCRIPTION OF THE DRAWINGS

Reference is made in the description to the following briefly described drawings, wherein like reference numerals refer to corresponding elements:

FIG. 1 is a front perspective view of a dispenser according to one aspect of the teachings of the present invention;

FIG. 2 is a front perspective view of the dispenser of FIG. 1 without housing panels;

FIG. 3 is a rear perspective view of the dispenser of FIG. 1 without housing panels;

FIG. 4 is a side view of various components of the dispenser of FIG. 1;

FIG. 5 is an isometric exploded view of a syrup container connector according to one aspect of the teachings of the present invention;

FIG. 6 is an isometric cross-sectional view of an assembled connector as shown in FIG. 5;

FIGS. 7 and 8 are cross-sectional views of two positions of the connector of FIG. 6;

FIG. 9 is a cross-sectional view of the connector of FIG. 6 coupled to a dispenser-receiving receptacle;

FIGS. 10 and 11 are perspective views of the connector of FIG. 6 in relation to a syrup container;

FIG. 12 is a front view of the dispenser of FIG. 1 without housing panels;

FIG. 13 is cross-sectional view of one embodiment of a carbonator tank and refrigeration system according to one aspect of the present invention; and

FIG. 14 is an exploded view of another embodiment of a carbonator tank and refrigeration system according to another aspect of the present invention.

### DETAILED DESCRIPTION OF THE INVENTION

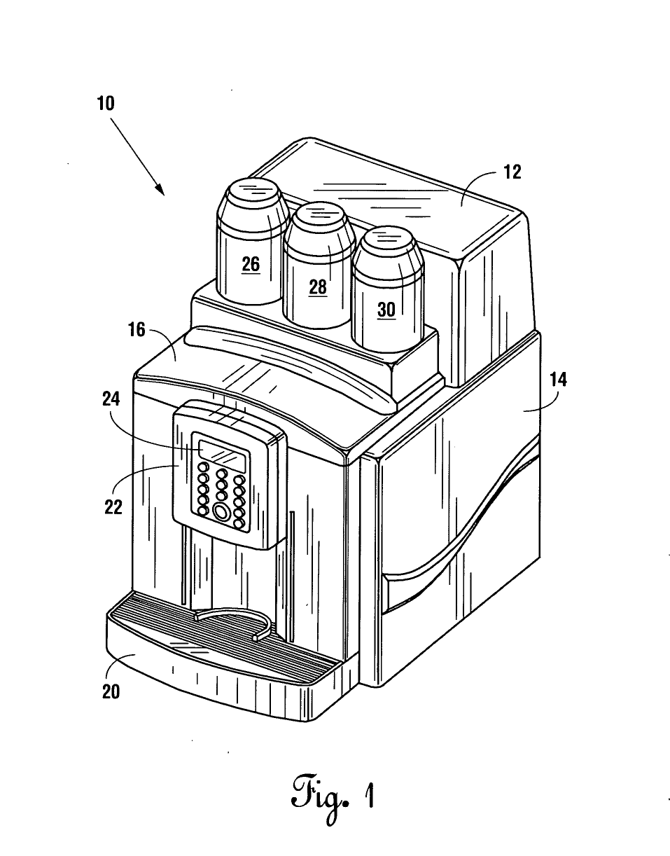

FIG. 1 shows a dispenser 10 according to one aspect of the present invention. Dispenser 10 includes a housing, including panels 12, 14, 16, and 18, and a dip tray assembly 20. A user operates the dispenser 10 with user interface 22, which includes a display panel 24. The particular dispenser 10 illustrated in FIG. 1 includes three syrup containers 26, 28, and 30 (also referred to as concentrate containers). However, three containers is an example only, and dispenser 10 may be designed to accommodate more or fewer containers than three.

One aspect of the present invention relates to the syrup containers. With regard to this aspect, the syrup containers may be conventional PET bottles, such as the 2-litre bottles commonly used for finished soft drinks. By using such bottles, no new package related costs, such as molds, are required. Although the use of conventional PET bottles is preferred, any suitable package may be used, including packages designed specifically for the dispenser.

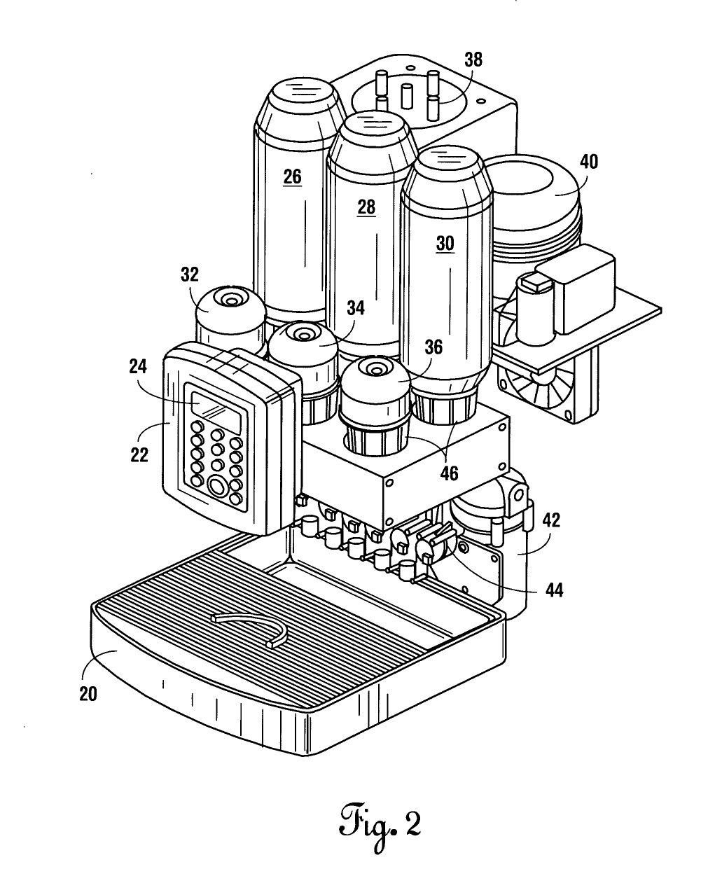

FIG. 2 shows dispenser 10 without panels 12, 14, 16, and 18. As shown, bonus flavor containers 32, 34, and 36 may be provided. Similar to the syrup containers 26-30, these may be, but need not be, made from conventional PET packages. Generally speaking, these bonus flavor containers are smaller than the syrup containers, as they hold flavors (for example, cherry and vanilla) that are added to drinks in relatively small quantities. The word “concentrate” may be used herein interchangeably with syrup or flavor.

Also shown is combination carbonator and refrigeration unit 38, compressor 40, and water pump 42, to be discussed below. Solenoid valves 44 are used to dispense syrup, water, and flavors, to form finished drinks. These valves 44 are controlled by the user interface 22, which may include, for example and without limitation, a microcontroller. This microcontroller, or a separate control circuit, may be used to control the refrigeration system. In general, the electronic system, whether an integrated control system or separate controllers, that controls operation of the dispenser may be referred to herein as a controller or system controller. Although solenoid valves 44 are illustrated, this is an example only, and any suitable valves, including, without limitation, volumetric valves, other metering valves, and LFCM valves, may be used.

Also shown in FIG. 2 are connectors 46, which are used to couple the syrup and bonus flavor containers to the dispenser 10, as will be discussed below.

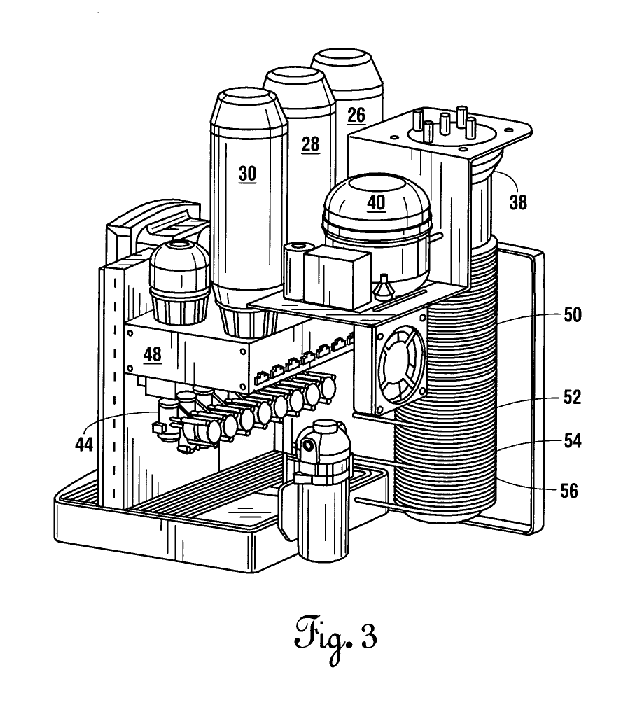

FIG. 3 shows a rear view of dispenser 10 without panels 12, 14, 16, and 18. A manifold 48 receives the syrup and bonus flavor containers, and couples each to the input of an appropriate solenoid valve 44. The syrup and flavors may flow through beverage lines that allow for cooling (as discussed below) before reaching the valves 44. The output of each solenoid valve is coupled to an output nozzle. One or more multiflavor nozzles, for dispensing more than one drink flavor, or multiple individual nozzles may be used. To save space, however, it is preferred that one multiflavor nozzle be used. Plain or carbonated water (soda) is also coupled to particular solenoid valves 44 for dispensing water, alone or in conjunction with the dispensing of syrup or bonus flavors. The plain water or soda may be coupled directly to the valves, or through the manifold 48.

As shown in FIG. 3, a water pre-cooling circuit 50 winds around carbonator/refrigeration unit 38 to pre-cool water before it enters the carbonator/refrigeration unit 38 for carbonation. Circuit 50 may also be split so that only some of the chilled plain water is sent to the carbonator for carbonation, while the remainder is available for dispensing of still beverages. Alternatively, a separate plain water line may be chilled before dispensing. Also, coils 52, 54, and 56 (which receive syrup from the containers 26, 28, and 30) are wound around the carbonator/refrigeration unit 38 for chilling of syrup before being dispensed. The coils 50-56 may be any suitable tubing, including, without limitation, stainless steel beverage tubing. The coils 50-56 may be upstream or downstream of the valves 44.

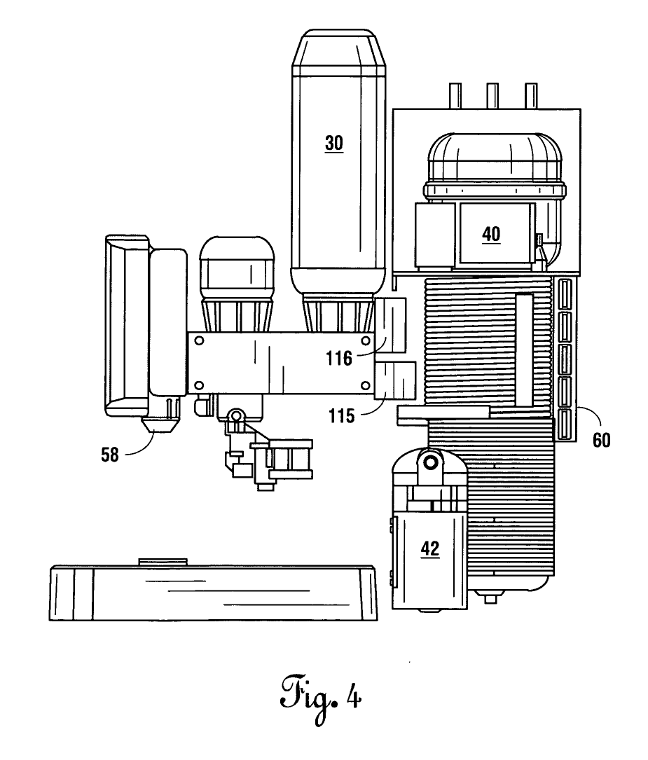

FIG. 4 shows a side view of dispenser 10 without panels 12, 14, 16, and 18. In particular, a multiflavor dispensing nozzle 58 is coupled to the valves 44. Finished beverages are dispensed through the nozzle 58, which results in mixing of water (plain or soda) with syrup or flavors, either in the nozzle 58 or in the air within or under the nozzle 58. Condenser coils 60, which are part of the refrigeration system, are also shown.

Also shown in FIG. 4 are sold-out sensors 115 and 116. These sensors sense whether any syrup container, or any flavor container, respectively, is out of product. Sensors 115 and 116 are coupled to and communicate with the system controller. Sensors 116 and 116 are illustrated schematically, and a sold-out sensor is preferably associated with each syrup and flavor container, so as to specifically identify which particular container is out of product. The system controller may be configured to indicate any out-of-product condition sensed by the sold-out sensors, and to disable dispensing for user requests for dispensing from out-of-product containers. Although sensors 115 and 116 are preferred, it should be understood that they are optional. Also, any suitable technology may be used for the sensors 115 and 116, including, without limitation, optical sensors.

FIG. 5 illustrates an exploded view of a connector 46. Connector 46 includes a lower housing 62 and a piston 64. Piston 64 is coupled to a syrup pin 66 and a gas pin 68. These pins each include an opening in their container end and a fluid flow path from the opening through their body to the connector 46. Piston 64 includes guides 70 and a gate cover 72. A gas valve 73 is coupled to the piston 64, and comprises a gas valve return spring 74, a gas valve sealing ring 76, and a gas valve piston 78. A syrup one-way valve 80 is also coupled to piston 64. An upper housing 82, which includes an internal helical thread 84, embraces the piston 64 and engages projections 85 of the piston 64.

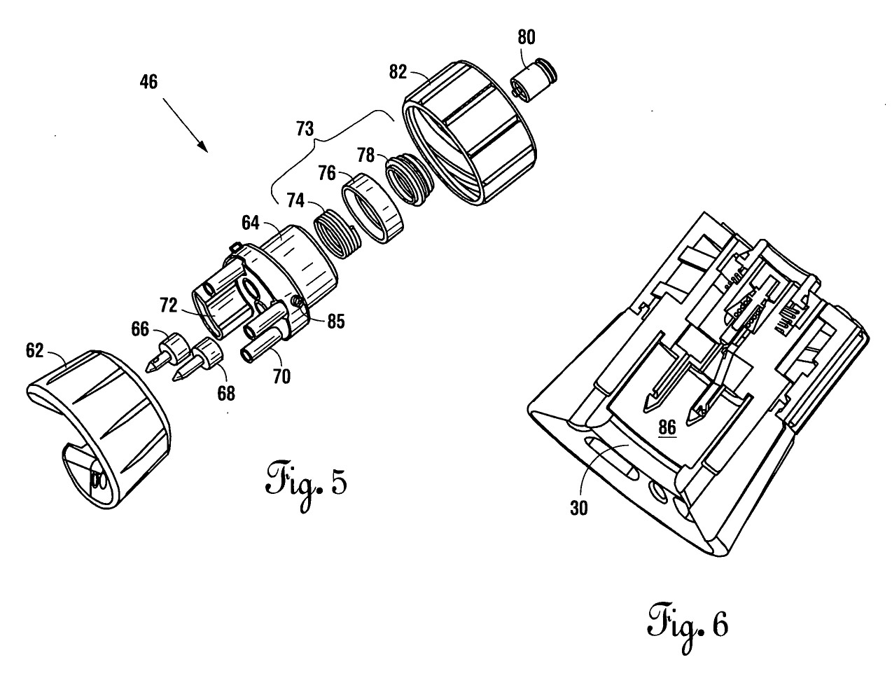

In particular, the projections 85 engage with the helical thread 84. Thus, as the upper housing 82 is rotated (with the lower housing 62 held stationary), the piston 66 moves linearly due to the action of the helical thread 84 on the projections 85. The guides 70 guide the linear motion of the piston 64 and travel in corresponding guide slots formed in lower housing 62. FIG. 6 shows the connector 46 in its assembled state, with the piston 64 fully displaced, such that pins 66 and 68 penetrate a closure 86 of a syrup container, such as syrup container 30.

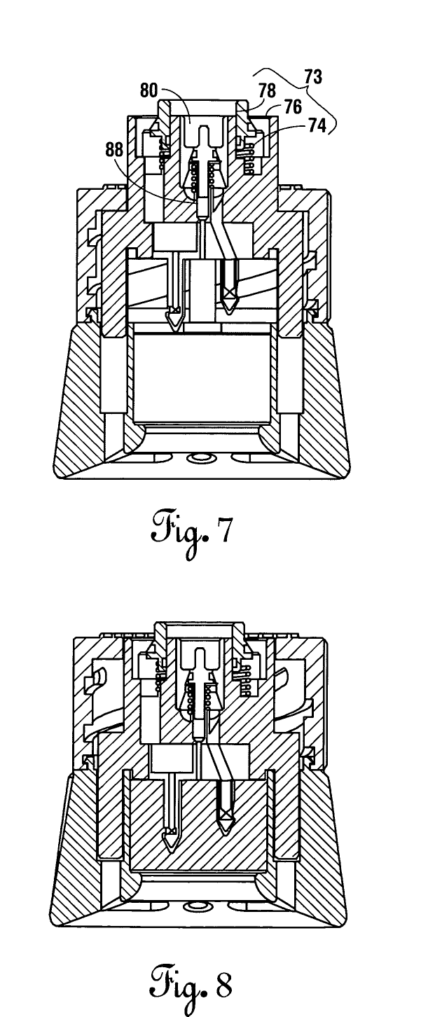

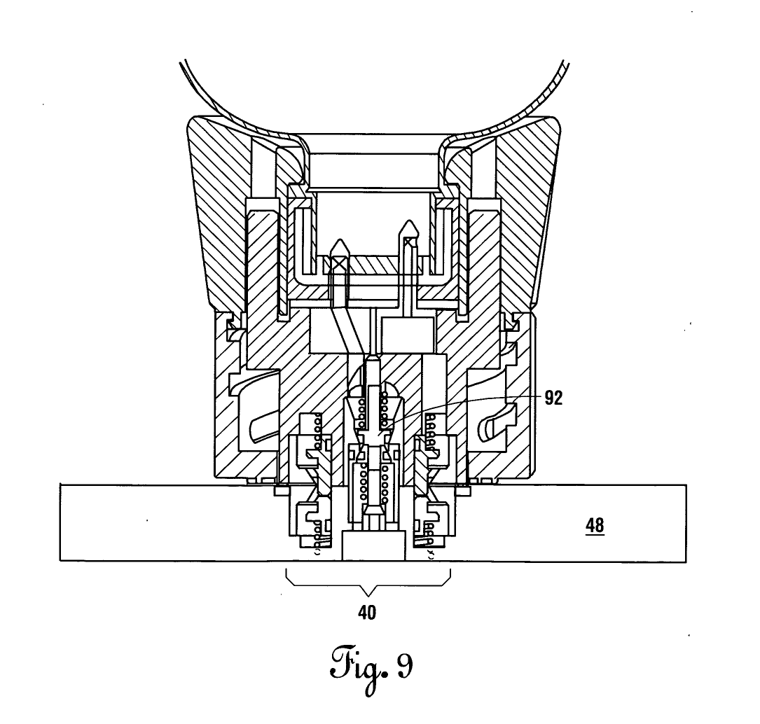

FIGS. 7 and 8 show the fully retracted and fully displaced piston positions of connector 46, respectively, while coupled to a syrup container. As shown in FIG. 7, in the fully retracted position, the piston 64 is retracted from the closure 86, such that pins 66 and 68 do not penetrate the closure 86. In FIG. 8, the upper housing 82 has been rotated, thereby moving the piston 64 linearly toward the closure 86, and allowing the pins 66 and 68 to puncture and penetrate the closure 86. The closure 86 is preferably made from a relatively soft plastic to allow appropriate sealing between the closure and the pins 66 and 68 as they puncture the closure 86. However, any suitable materials or sealing mechanisms may be used. Furthermore, although a rotating mechanism is illustrated, any suitable mechanism, including, without limitation, a lever mechanism, may be used to allow the pins to puncture the closure 86. Also, the syrup or flavor containers may be closed in any suitable way, and the penetration of the pins 66 and 68 may be made through any suitable location or part of the containers, not necessarily through a closure such as closure 86.

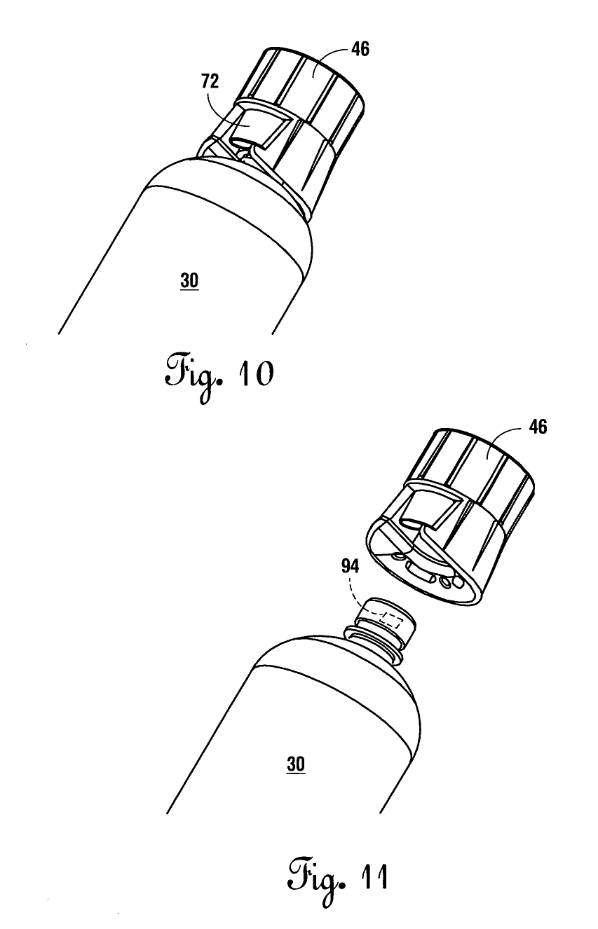

As can be seen in FIGS. 7 and 8, fluid flow paths are provided from syrup pin 66 to syrup valve 80, and from gas valve 73 to gas pin 68. The syrup and gas valves are normally closed, due to the closing bias of a syrup valve spring 88 and gas valve return spring 74. However, as shown in FIG. 9, when the connector 46 is engaged with a receptacle 90 of manifold 48, the syrup and gas valves are opened to allow fluid communication with the manifold 48 and valves 44. In particular, the receptacle 90 includes spring loaded syrup and gas valves that mirror those of the connector 46. As the connector 46 is mated in the receptacle 90, the matching valves overcome the closing bias of the biasing springs, thus opening the valves. In particular, a valve stem 92 of the syrup valve 80 is forced toward the syrup container, unseating the stem from a sealing shoulder, thus opening the syrup path from the syrup container to the manifold 48. Likewise, the gas valve piston 78 unseats from the gas valve sealing ring 76, thereby opening the gas path from the manifold to the syrup container. Gas, such as CO₂ for example, is supplied to the manifold 48 for pressurizing the syrup and bonus flavor containers through the connectors 46 and gas pins 68. This gas pressure allows dispensing of the syrups and flavors without need for a dispensing pump. It should be understood that the particular valves are examples, and other valving and sealing mechanisms may be used.

FIGS. 10 and 11 illustrate coupling of connector 46 to a syrup container. Gate cover 72 snaps onto closure 86 to hold the connector 46 in place. Also, FIG. 11 illustrates an RFID tag 94 coupled to the closure 86 of the syrup container. This RFID tag may include various information regarding the syrup container, to be read by the controller of the dispenser 10. For example, and without limitation, the RFID tag may include information on the kind of syrup in the container, its expiration date, a unique identifier code, and the proper syrup-to-water mix ratio. With this information, the dispenser can disable use of unauthorized syrups and out of date syrups. Also, with this information, the dispenser can keep track of how many and what kind of syrup containers have been used, thus allowing cleaning and maintenance scheduling, and use/sales tracking. While an RFID approach is preferred, any suitable identification method may be used, including, without limitation, bar coding or the use of magnetic stripe data recording and reading.

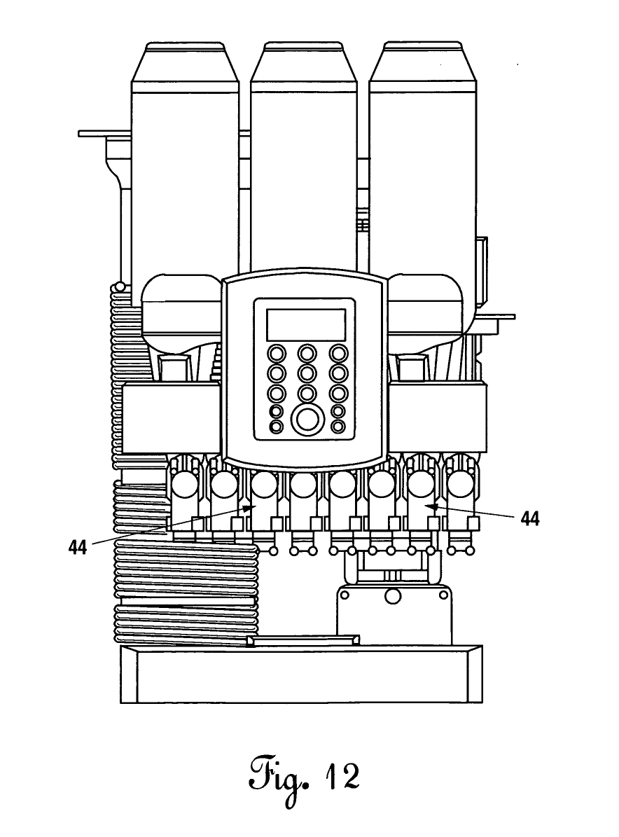

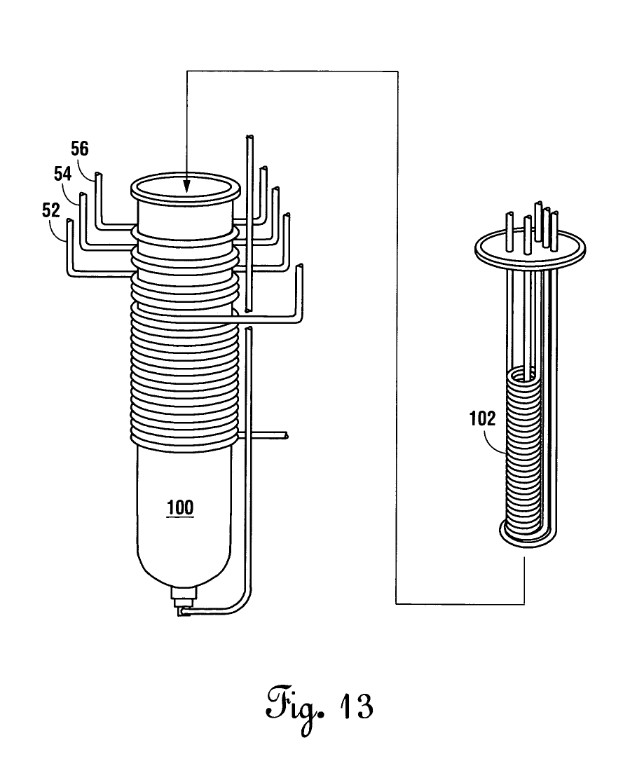

FIG. 12 shows a front view of dispenser 10 without panels 12, 14, 16, and 18, and illustrates the valves 44.

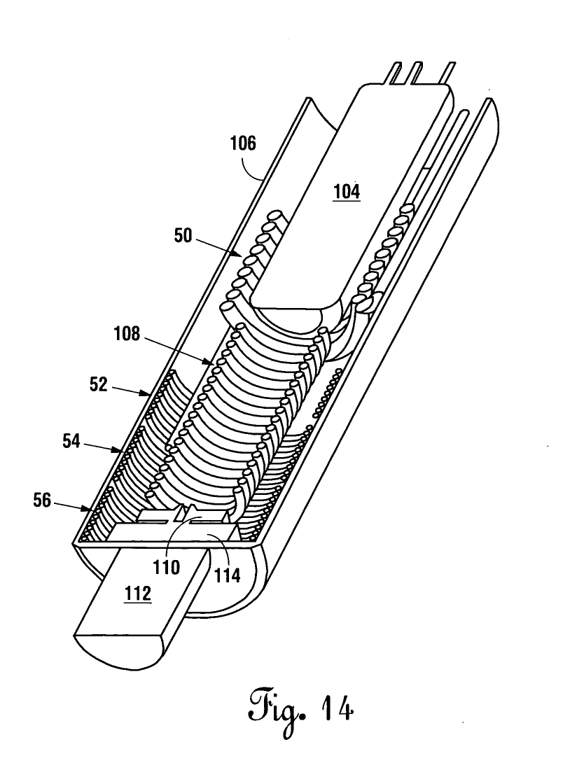

FIG. 13 is an exploded view of one embodiment of the combined carbonation and refrigeration unit 38. As shown, the unit 38 includes a carbonator tank 100, which may be made of stainless steel. An evaporator coil 102 of a mechanical refrigeration system is located within the carbonator tank 100. This allows the carbonator tank 100 to be cold, providing efficient cooling of the beverage lines (water and syrup) that are coiled around the carbonator tank 100, and allowing for efficient carbonation. The evaporator coil 102 produces an ice bank within the carbonator tank 100. Any suitable approach for controlling the size of the ice bank may be used, including, without limitation, a mechanical ice bank control switch or a temperature set point. Also, any suitable approach for controlling carbonation, including, without limitation, water level probes, may be used.

As discussed above, the water line may be split, so that chilled plain water is used both for dispensing still beverages and for supply to the carbonator for producing soda. Syrup lines may be coiled around the carbonator tank 100 for chilling prior to dispensing.

FIG. 14 illustrates a cross-sectional view of another embodiment of a combination carbonator and refrigeration system according the one aspect of the present invention. As shown, the water and syrup lines 50-56, carbonator 104, and an evaporator 108 are located within an enclosure 106. By enclosing these elements together, efficient cooling is achieved, both due to their close proximity and the enclosure 106. Also, an agitator 110 is provided for circulating water around the ice bank that forms around evaporator 108, thus improving cooling efficiency. In a preferred embodiment, the agitator 110 is an impeller that is magnetically coupled to a motor 112, either directly or through a recirculation pump 114 that is magnetically coupled to the motor 112. The recirculation pump 114 provides the ability to flow cold recirculation water through tubes held in close proximity with beverage tubes in areas outside the enclosure 106, thus minimizing heating of lines, and helping to ensure low temperature dispensing.

In operation of the system, a user selects the desired beverage using the user interface 22. In response, the system controller opens the appropriate valves 44 to dispense either water or soda, and the proper syrup or flavor. The water or soda is pressurized by the water source or carbonation system, respectively, and thus flows without need of a dispensing pump. The syrup and bonus flavors are pressurized by gas that enters the syrup or flavor containers via the gas pins 68 of connectors 46. This gas is any suitable gas, including, without limitation, CO₂ or N₂. Thus, no dispensing pump is needed for the syrup, either.

The dispenser 10 integrates carbonation, cooling, and syrup and flavor containers in a single unit. This integration provides an efficient use of space, thereby creating a relatively small-size dispenser. This small size is important in many applications, where counter-top space is valuable. Although this integration is an important technical advantage, there are several aspects of the dispenser 10 that may be applied in other contexts, such as the connector 46 and the combination carbonation and refrigeration units.

The system controller of dispenser 10 may be (although need not be) coupled to an authorization system, such as, without limitation, a payment system, so that dispensing is enabled only upon authorization (e.g., payment). Any suitable authorization system may be used, including, without limitation, coin mechanisms, bill acceptors, prepaid account systems, and credit/debit card systems.

Within this description, coupling includes both direct coupling of elements, and coupling indirectly through intermediate elements.

The particular embodiments and descriptions provided herein are illustrative examples only, and features and advantages of each example may be interchanged with, or added to the features and advantages in the other embodiments and examples herein. Moreover, as examples, they are meant to be without limitation as to other possible embodiments, are not meant to limit the scope of the present invention to any particular described detail, and the scope of the invention is meant to be broader than any example. Also, the present invention has several aspects, as described above, and they may stand alone, or be combined with some or all of the other aspects.

And, in general, although the present invention has been described in detail, it should be understood that various changes, alterations, substitutions, additions and modifications can be made without departing from the intended scope of the invention, as defined in the following claims.

What is claimed is:

1. A beverage dispenser, comprising:
a concentrate container containing concentrate;
a connector coupled to the concentrate container, the connector comprising a gas pin and a concentrate pin, the pins penetrating the container, each pin comprising an opening and a fluid flow path through the pin, such that a gas flow path is provided into the container through the gas pin and a concentrate flow path is provided from the container to the connector;
a gas source coupled to the gas pin through the connector, the gas source supplying gas at a gas pressure; and
a concentrate dispensing valve coupled to the concentrate pin through the connector, such that, upon activation of the concentrate dispensing valve, concentrate flows from the concentrate container through the concentrate pin and the concentrate dispensing valve due to the gas pressure.

2. The beverage dispenser of claim 1, wherein the concentrate container is a 2-litre PET package.

3. The beverage dispenser of claim 1, wherein the connector comprises a piston coupled to a rotatable upper housing, and the pins are coupled to the piston, and wherein rotation of the upper housing causes the piston to move toward or away from the concentrate container.

4. The beverage dispenser of claim 3, wherein rotation of the upper housing in one direction moves the piston away from the concentrate container such that the pins are withdrawn from the container, and rotation in the other direction moves the piston toward the concentrate container such that the pins penetrate the concentrate container.

5. The beverage dispenser of claim 1, wherein the connector comprises a normally closed gas valve coupled to the gas pin, and a normally closed concentrate valve coupled to the concentrate pin.

6. The beverage dispenser of claim 5, further comprising a receiving receptacle for receiving the connector, wherein the normally closed gas and concentrate valves open when the connector is coupled to the receptacle.

7. The beverage dispenser of claim 1, and further comprising a controller, and an RFID tag coupled to the concentrate container, the controller being able to read information from the RFID tag.

8. The beverage dispenser of claim 7, wherein the information comprises data relating to the expiration date of the concentrate in the concentrate container, and the kind of concentrate in the container.

9. The beverage dispenser of claim 7, wherein the information comprises data that authenticates the concentrate container as an authorized container for use with the dispenser.

10. The beverage dispenser of claim 9, wherein the controller disables use of unauthorized containers.

11. The beverage dispenser of claim 1, and further comprising a bonus flavor container for supplying bonus flavors.

12. The beverage dispenser of claim 1, and further comprising a carbonator tank for producing soda, the soda being coupled to a soda dispensing valve.

13. The beverage dispenser of claim 12, and further comprising an evaporator inside the carbonator tank, such that the carbonator tank and soda in the carbonator tank are chilled.

14. The beverage dispenser of claim 13, and further comprising a concentrate line wound around the carbonator tank, the concentrate line coupled to the concentrate pin and carrying concentrate from the concentrate container, such that the concentrate is cooled by heat transfer to the carbonator tank.

15. The beverage dispenser of claim 13, and further comprising a water line wound around the carbonator tank, the water line coupled to a source of water and carrying water, such that the water is cooled by heat transfer to the carbonator tank.

16. The beverage dispenser of claim 15, wherein the cooled water is communicated to the carbonator tank to produce soda.

17. The beverage dispenser of claim 1, and further comprising an enclosure enclosing a carbonator tank, an evaporator, cooling water, and a concentrate line, such that the evaporator creates an ice bank from the cooling water, thereby cooling the carbonator tank and the concentrate line.

18. The beverage dispenser of claim 17, and further comprising a water line within the enclosure.

19. The beverage dispenser of claim 17, and further comprising an agitator within the enclosure magnetically coupled to a motor outside the enclosure, the agitator circulating water around the ice bank.

20. The beverage dispenser of claim 17, and further comprising beverage lines outside the enclosure and a recirculation pump within the enclosure magnetically coupled to a motor outside the enclosure, the recirculation pump for pumping cool water from the enclosure to cool the beverage lines.
